(19) United States
(12) Patent Application Publication
(10) Pub. No.: US 2015/0189548 A1
(43) Pub. Date: Jul. 2, 2015

(54) METHODS AND APPARATUS FOR JOINT POWER AND RESOURCE MANAGEMENT

(71) Applicant: QUALCOMM Incorporated, San Diego, CA (US)

(72) Inventors: Aitzaz AHMAD, San Diego, CA (US); Chirag Sureshbhai PATEL, San Diego, CA (US); Christophe CHEVALLIER, San Diego, CA (US); Rajat PRAKASH, San Diego, CA (US)

(21) Appl. No.: 14/446,809

(22) Filed: Jul. 30, 2014

Related U.S. Application Data
(60) Provisional application No. 61/920,811, filed on Dec. 26, 2013.

(51) Int. Cl. H04W 28/08; H04W 72/04; H04W 52/26

(52) U.S. Cl. CPC H04W 28/08; H04W 52/26; H04W 72/0486

(57) ABSTRACT

Methods and apparatus for communication comprise adjusting a transmission power value of one or both of a network entity and a proximate network entity from a first transmission power value to a second transmission power value based at least in part on one or both of a load level value of the network entity and a load level value of the proximate network entity to offload at least one user equipment (UE) to the proximate network entity, wherein the network entity serves the at least one UE. Further, the methods and apparatus comprise updating a power/resource management policy at the network entity based on adjusting the transmission power value of one or both of the network entity and the proximate network entity.

### CLAIM OF PRIORITY UNDER 35 U.S.C. §119

The present application for patent claims priority to Provisional Application No. 61/920,811 entitled “METHODS AND APPARATUS FOR JOINT POWER AND RESOURCE MANAGEMENT” filed Dec. 26, 2013, and assigned to the assignee hereof and hereby expressly incorporated by reference herein.

### BACKGROUND

Aspects of the present disclosure relate generally to wireless communication, and more particularly, to methods and apparatus for joint power and resource management at a network entity.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of eNodeBs that can support communication for a number of user equipments (UEs). A UE may communicate with an eNodeB via the downlink and uplink. The downlink (or forward link) refers to the communication link from the eNodeB to the UE, and the uplink (or reverse link) refers to the communication link from the UE to the eNodeB.

In some wireless communication networks, a user equipment (UE) selects and maintains a connection with a macro base station providing communication capabilities for the UE. Further, in such wireless communication systems, small cells (e.g., Home Node/eNode B) are deployed to improve wireless network communications when experiencing poor macro base station signal quality. In such wireless communication networks, inefficient management and/or utilization of communication resources, particularly resources for small cell power and resource management, may lead to degradations in user experience.

Even more, the foregoing inefficient resource management and/or utilization inhibits network devices from achieving higher wireless communication quality. In view of the foregoing, it may be understood that there may be significant problems and shortcomings associated with current power and resource management technology. Thus, improvements in power and resource management are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of communication includes adjusting a transmission power value of one or both of a network entity and a proximate network entity from a first transmission power value to a second transmission power value based at least in part on one or both of a load level value of the network entity and a load level value of the proximate network entity to offload at least one user equipment (UE) to the proximate network entity, wherein the network entity serves the at least one UE. Further, the method includes updating a power/resource management policy at the network entity based on adjusting the transmission power value of one or both of the network entity and the proximate network entity.

In another aspect, a computer program product comprising a computer-readable medium includes at least one instruction executable to cause a computer to adjust a transmission power value of one or both of a network entity and a proximate network entity from a first transmission power value to a second transmission power value based at least in part on one or both of a load level value of the network entity and a load level value of the proximate network entity to offload at least one UE to the proximate network entity, wherein the network entity serves the at least one UE. Further, the computer-readable medium includes at least one instruction executable to cause a computer to update a power/resource management policy at the network entity based on adjusting the transmission power value of one or both of the network entity and the proximate network entity.

In a further aspect, an apparatus for communication includes means for adjusting a transmission power value of one or both of a network entity and a proximate network entity from a first transmission power value to a second transmission power value based at least in part on one or both of a load level value of the network entity and a load level value of the proximate network entity to offload at least one UE to the proximate network entity, wherein the network entity serves the at least one UE. Further, the apparatus comprises means for updating a power/resource management policy at the network entity based on adjusting the transmission power value of one or both of the network entity and the proximate network entity.

In an additional aspect, an apparatus for communication comprising a memory storing executable instructions and a processor in communication with the memory, wherein the processor is configured to execute the instructions to adjust a transmission power value of one or both of a network entity and a proximate network entity from a first transmission power value to a second transmission power value based at least in part on one or both of a load level value of the network entity and a load level value of the proximate network entity to offload at least one UE to the proximate network entity, wherein the network entity serves the at least one UE. Further, the processor is configured to execute the instructions to update a power/resource management policy at the network entity based on adjusting the transmission power value of one or both of the network entity and the proximate network entity.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is a block diagram conceptually illustrating an example of a telecommunications system in accordance with an aspect of the power/resource management component.

FIG. 2 is a block diagram conceptually illustrating an example of the power/resource management component in accordance with an aspect described herein, e.g., according to FIG. 1.

FIG. 3 is a conceptual diagram of an example communication environment in accordance with an aspect of the present disclosure, e.g., according to FIGS. 1 and 2.

FIG. 4 is a flow chart illustrating a method of communication in accordance with an aspect of the present disclosure, e.g., according to FIGS. 1 and 2.

FIG. 5 is a flow chart illustrating another aspect of a method of communication in accordance with an aspect of the present disclosure, e.g., according to FIGS. 1 and 2.

FIG. 6 is a block diagram conceptually illustrating an example of a downlink frame structure in a telecommunications system in accordance with an aspect of the present disclosure, e.g., according to FIG. 1.

FIG. 7 is a block diagram conceptually illustrating an exemplary eNodeB and an exemplary UE configured in accordance with an aspect of the present disclosure, e.g., according to FIG. 1.

FIG. 8 illustrates an exemplary communication system to enable deployment of small cells/nodes within a network environment including an aspect of the user equipment described herein.

FIG. 9 illustrates a continuous carrier aggregation type in accordance with an aspect of the present disclosure, e.g., according to FIG. 1.

FIG. 10 illustrates a non-continuous carrier aggregation type in accordance with an aspect of the present disclosure, e.g., according to FIG. 1.

FIG. 11 illustrates an example block diagram of a logical grouping of electrical components in accordance with an aspect of the present disclosure, e.g., according to FIGS. 1 and 2.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

The present aspects generally relate to joint power and resource management procedures for managing inter-small cell interference. Specifically, in some wireless communication systems, power management and resource management may be conducted at a small cell in a disjoint manner such that power related information may not be considered for resource management, and resource related information may be ignored when performing power management. In other words, static power management and resource management procedures are utilized. As such, small cells may fail to jointly manage both their power and resources to achieve optimal load balancing and throughput.

Accordingly, in some aspects, the present methods and apparatus may provide an efficient and effective solution, as compared to current solutions, to provide enhanced power management and resource management at small cells in a joint and/or dynamic manner. In an aspect, the present apparatus and methods include a small cell solution configured to perform a power/resource management procedure to update a power/resource management policy of the small cell corresponding to an adjustment of characteristic transmission power value of one or both of the small cell and a proximate or neighboring small cell.

The term “small cell,” as used herein, refers to a relative low transmit power and/or a relatively small coverage area cell as compared to a transmit power and/or a coverage area of a macro cell. Further, the term “small cell” may include, but is not limited to, cells such as a femto cell, a pico cell, access point base stations, evolved Node Bs, Home NodeBs, or femto access points, or femto cells. For instance, a macro cell may cover a relatively large geographic area, such as, but not limited to, several kilometers in radius. In contrast, a pico cell may cover a relatively small geographic area, such as, but not limited to, a building. Further, a femto cell also may cover a relatively small geographic area, such as, but not limited to, a home, or a floor of a building.

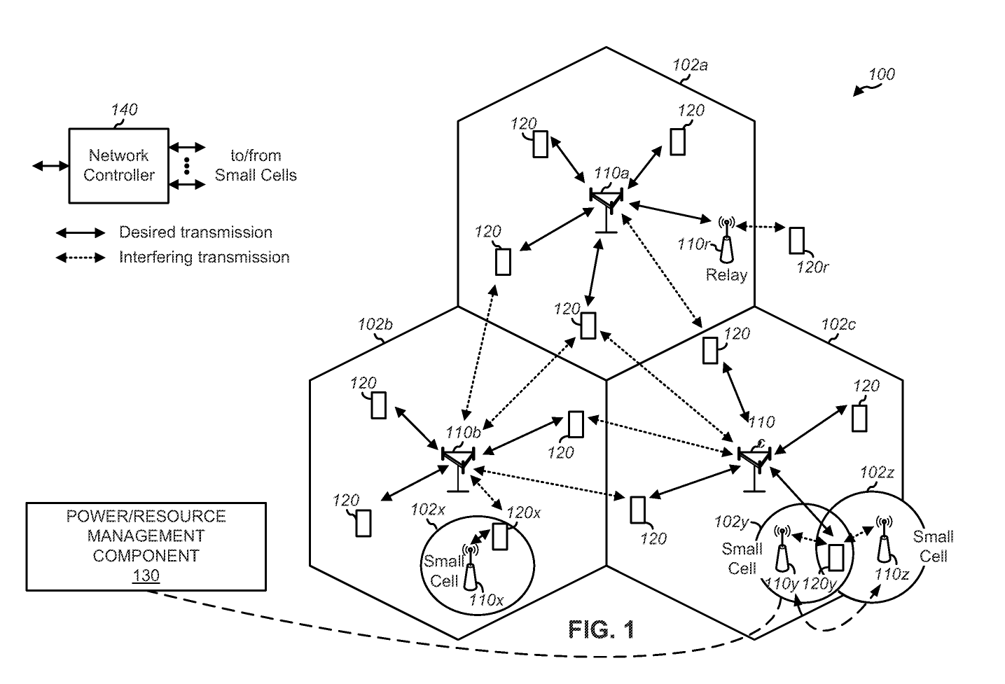

FIG. 1 is a block diagram conceptually illustrating an example of a telecommunications network system 100 in accordance with an aspect of the present disclosure. Telecommunications network system 100 may include one or more small cells 110, for example, one or more evolved NodeBs (eNodeBs). In such aspects, a small cell may also be referred to as a network entity. Each small cell 110 may include power/resource management component 130, which may be configured to manage, in a joint and dynamic manner, both the power and resource aspects of each small cell 110.

For example, after initialization of at least one small cell 110 (e.g., small cell 110y), power/resource management component 130 may perform a power/resource management procedure to adjust a transmission power value and may correspondingly update its power/resource management policy, or have its power/resource management policy updated through coordination over a backhaul interface (e.g., via network controller 140).

In other words, power/resource management component 130 may be configured to adjust a transmission power value of small cell 110y and/or proximate small cell 110z to offload at least one UE (e.g., UE 120y) to the proximate small cell 110z. In such aspects, small cell 110y may be considered the serving small cell for UE 120y. Moreover, in some aspects, small cell 110y may decrease its own transmission power and/or proximate small cell 110z may increase its transmission power to offload one or more UEs, such as UE 120y to the proximate small cell 110z, thereby balancing the load level and increasing the available throughput for the remaining UEs served by small cell 110y. In some aspects, the load level and/or a load level value may be a value indicative of a number of users (e.g., high demand users) served and/or a number of resourced in use by one or more users at a small cell.

For instance, small cell 110y may offload UE 120y to proximate small cell 110z to decrease the load level at small cell 110y. Additionally, power/resource management component 130 may update a power/resource management policy at small cell 110y upon an adjustment of a transmission power value at small cell 110y and/or proximate small cell 110z. Additionally, the updated power/resource management policy may be communicated to other small cells in order to assist the other small cells determine optimal transmission power levels and resource levels based on the adjustments made at the small cell providing the updated power/resource management policy.

In some aspects, the one or more small cells may include, or communication according to at least one technology such as, but not limited to, long term evolution (LTE), universal mobile telecommunications system (UMTS), code division multiple access (CDMA) 2000, wireless local area network (WLAN) (e.g., WiFi). Further, the transmission-related parameters associated with each of the one or more network entities, such as the foregoing non-limiting example network entities may include, but are not limited to, physical cell identity (PCI), primary synchronization code (PSC), pseudo-random noise code (PN), channel numbers and/or beacon patterns.

Moreover, for example, the telecommunications network system 100 may be an LTE network or some other wide wireless area network (WWAN). As such, the telecommunications network system 100 may include a number of eNodeBs 110, each of which may include power/resource management component 130, and UEs 120 and other network entities. An eNodeB 110 may be a station that communicates with the UEs 120 and may also be referred to as a base station, an access point, etc. A NodeB may be another example of a station that communicates with the UEs 120.

Each eNodeB 110 may provide communication coverage for a particular geographic area. In 3GPP, the term “cell” can refer to a coverage area of an eNodeB 110 and/or an eNodeB subsystem serving the coverage area, depending on the context in which the term is used.

An eNodeB 110 may provide communication coverage for a macro cell, a pico cell, a femto cell, and/or other types of cell. A macro cell may cover a relatively large geographic area (e.g., several kilometers in radius) and may allow unrestricted access by UEs 120 with service subscription. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 may be subscribed to a Closed Subscriber Group (CSG), UEs 120 for users in the home, etc.).

An eNodeB 110 for a macro cell may be referred to as a macro eNodeB. An eNodeB 110 for a pico cell may be referred to as a pico eNodeB. An eNodeB 110 for a femto cell may be referred to as a femto eNodeB or a home eNodeB. In the example shown in FIG. 1, the eNodeBs 110a, 110b and 110c may be macro eNodeBs for the macro cells 102a, 102b and 102c, respectively. The eNodeB 110x may be a pico eNodeB for a pico cell 102x. The eNodeBs 110y and 110z may be femto eNodeBs for the femto cells 102y and 102z, respectively. An eNodeB 110 may provide communication coverage for one or more (e.g., three) cells. It should be understood that each of the eNodeBs may include power/resource management component 130.

The telecommunications network system 100 may include one or more relay stations 110r and 120r, that may also be referred to as a relay eNodeB, a relay, etc. The relay station 110r may be a station that receives a transmission of data and/or other information from an upstream station (e.g., an eNodeB 110 or a UE 120) and sends the received transmission of the data and/or other information to a downstream station (e.g., a UE 120 or an eNodeB 110). The relay station 120r may be a UE that relays transmissions for other UEs (not shown). In the example shown in FIG. 1, the relay station 110r may communicate with the eNodeB 110a and the UE 120r in order to facilitate communication between the eNodeB 110a and the UE 120r.

The telecommunications network system 100 may be a heterogeneous network that includes eNodeBs 110 of different types, e.g., macro eNodeBs 110a-c, pico eNodeBs 110x, femto eNodeBs 110y-z, relays 110r, etc. These different types of eNodeBs 110 may have different transmit power levels, different coverage areas, and different impact on interference in the telecommunications network system 100. For example, macro eNodeBs 110a-c may have a high transmit power level (e.g., 20 Watts) whereas pico eNodeBs 110x, femto eNodeBs 110y-z and relays 110r may have a lower transmit power level (e.g., 1 Watt).

The telecommunications network system 100 may support synchronous or asynchronous operation. For synchronous operation, the eNodeBs 110 may have similar frame timing, and transmissions from different eNodeBs 110 and may be approximately aligned in time. For asynchronous operation, the eNodeBs 110 may have different frame timing, and transmissions from different eNodeBs 110 and may not be aligned in time. The techniques described herein may be used for both synchronous and asynchronous operation.

A network controller 140 may be coupled to a set of eNodeBs 110 and provide coordination and control for these eNodeBs 110. The network controller 140 may communicate with the eNodeBs 110 via a backhaul (not shown). The eNodeBs 110 may also communicate with one another, e.g., directly or indirectly via wireless or wire line backhaul (e.g., X2 interface) (not shown).

The UEs 120 (e.g., 120x, 120y, etc.) may be dispersed throughout the telecommunications network system 100, and each UE 120 may be stationary or mobile. For example, the UE 120 may be referred to as a terminal, a mobile station, a subscriber unit, a station, etc. In another example, the UE 120 may be a cellular phone, a personal digital assistant (PDA), a wireless modem, a wireless communication device, a handheld device, a laptop computer, a cordless phone, a wireless local loop (WLL) station, a tablet, a netbook, a smart book, etc.

The UE 120 may be able to communicate with macro eNodeBs 110a-c, pico eNodeBs 110x, femto eNodeBs 110y-z, relays 110r, etc. For example, in FIG. 1, a solid line with double arrows may indicate desired transmissions between a UE 120 and a serving eNodeB 110, which is an eNodeB 110 designated to serve the UE 120 on the downlink and/or uplink. A dashed line with double arrows may indicate interfering transmissions between a UE 120 and an eNodeB 110.

LTE may utilize orthogonal frequency division multiplexing (OFDM) on the downlink and single-carrier frequency division multiplexing (SC-FDM) on the uplink. OFDM and SC-FDM may partition the system bandwidth into multiple (K) orthogonal subcarriers, which are also commonly referred to as tones, bins, etc. Each subcarrier may be modulated with data. In general, modulation symbols may be sent in the frequency domain with OFDM and in the time domain with SC-FDM. The spacing between adjacent subcarriers may be fixed, and the total number of subcarriers (K) may be dependent on the system bandwidth.

For example, the spacing of the subcarriers may be 15 kHz and the minimum resource allocation (called a ‘resource block’) may be 12 subcarriers (or 180 kHz). Consequently, the nominal Fast Fourier Transform (FFT) size may be equal to 128, 256, 512, 1024 or 2048 for system bandwidth of 1.25, 2.5, 5, 10 or 20 megahertz (MHz), respectively. The system bandwidth may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

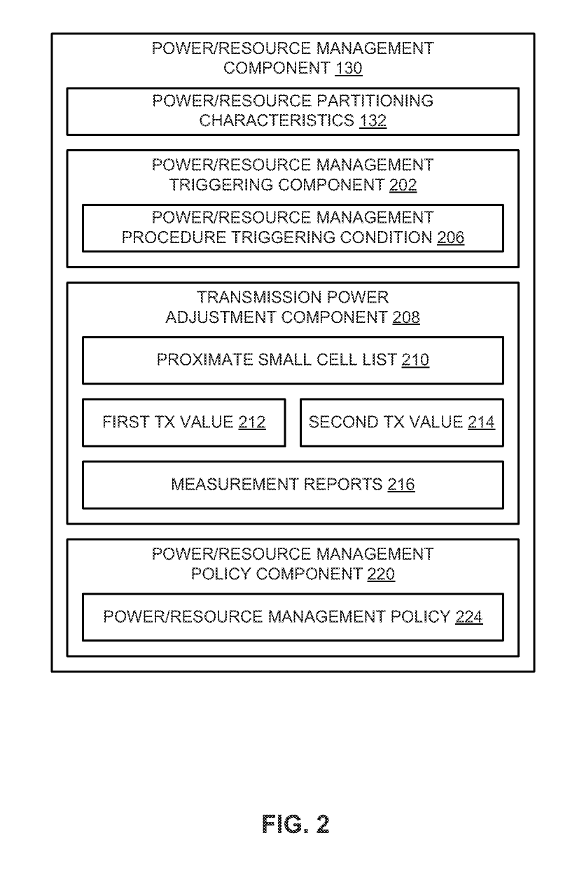

Referring to FIG. 2, in an aspect, power/resource management component 130 may include various component and/or subcomponents, which may be configured to provide joint power management and resource management. For example, power/resource management component 130 may be configured to adjust a transmission power value at one or both of a small cell serving a UE, or a proximate small cell in order to offload at least the UE to the proximate small cell, and thereby balance the load level at the serving small cell experiencing congestion. Further, an update to a power/resource management policy may be made to record or otherwise log the adjustments and any corresponding adjustments to one or more resource levels.

In an aspect, power/resource management component 130 may be configured to periodically determine whether to update its power/resource management policy based on the power/resource management procedure triggering condition 206. Specifically, in order to determine that the power/resource management procedure triggering condition 206 has been met, power/resource management component 130 may be configured to receive one or more power/resource partitioning characteristics 132 from at least one proximate small cell (e.g., proximate small cell 110z, FIG. 1) including or otherwise indicative of one or more measurements related to or from a perspective of the at least one proximate small cell.

For example, small cell 110y (FIG. 1) may receive one or more power/resource partitioning characteristics 132 from small cell 110z (FIG. 1). In other aspects, small cell 110y may receive the one or more power/resource partitioning characteristics 132 from a measurement report provided by a UE (e.g., UE 120y, FIG. 1). Further, in some aspects, the one or more power/resource partitioning characteristics 132 may include one or more of a load level value, a number of edge UEs, a resource management status, a transmission power value, and a minimum throughput value. In such aspects, the load level value may include a load level value of the network entity serving the UE and the one or more proximate network entities.

In such aspects, power/resource management component 130 may include power/resource management triggering component 202, which may be configured to determine a power/resource management procedure triggering condition 206 based on one or more power/resource partitioning characteristics 132 for triggering adjustment of the a transmission power value of one or both of a small cell serving a UE and/or a proximate small cell. Specifically, in one aspect, power/resource management triggering component 202 may be configured to determine or otherwise detect the power/resource management procedure triggering condition 206 based on determining that a number of high demand UEs meets or exceeds a high demand UE load threshold value.

For instance, power/resource management component 130 may determine that small cell 110y (FIG. 1) may be serving many high demand UEs (e.g., a number of high data demand UEs meets or exceeds a threshold value). In other words, a high demand UE may be a UE that may be communicating at a high data rate, utilizing a large amount of bandwidth relative to other UEs, and/or represents a larger percentage of a load level value at the small cell. Further, in some aspects, the load level and/or a load level value may be a value indicative of a number of users (e.g., high demand users) served and/or a number of resourced in use by one or more users at a small cell.

In another aspect, power/resource management triggering component 202 may be configured to determine or otherwise detect the power/resource management procedure triggering condition 206 based on determining that a number of reduced communication quality UEs meets or is less than a reduced communication quality UE threshold value. For example, power/resource management component 130 may determine that some UEs served by small cell 110y (FIG. 1) cannot be served with a certain minimum data rate and/or a quality of service. In other words, a reduced communication quality UE may be a UE that demonstrates a degradation in its communication quality according to any one or more of a signal-to-noise ratio (SINR) value, a minimum data rate value, and a quality of service (QoS) value.

As such, power/resource management component 130 may be configured to perform one or more power/resource management procedures according to the transmission power adjustment component 208 and/or the power/resource management policy component 220 to update a power/resource management policy corresponding to an adjustment of characteristic transmission power of serving small cell (e.g., small cell 110y) and/or proximate small cell (e.g., small cell 110z). For example, upon detecting the power/resource management procedure triggering condition 206, transmission power adjustment component 208 may be configured to adjust a transmission power of the serving small cell to offload one or more users to one or more proximate cells and/or request one or more proximate cells to adjust their respective transmission power.

In one aspect, power/resource management component 130 may include transmission power adjustment component 208, which may be configured to adjust a transmission power value of the serving small cell (e.g., small cell 110y, FIG. 1) from a first transmission value 212 (e.g., first Tx value 212) to a second transmission value 214 (e.g., second Tx value 214) to offload one or more UEs to at least one proximate small cell (e.g., small cell 110z, FIG. 1). In some aspects, small cell 110y (FIG. 1) may be configured to reduce or decrease its transmission power to the second transmission value 214, which may be smaller in value than the first transmission value 212.

Specifically, to accomplish such aspects, transmission power adjustment component 208 may be configured to receive one or more measurement reports 216 from a number of UEs 120 located at an edge region of the small cell (e.g., UE 120y located at edge region of small cell 110y and small cell 110z, FIG. 1). Further, transmission power adjustment component 208 may be configured to form a list of proximate small cells (e.g., proximate small cell list 210) including one or more proximate small cells (e.g., small cell 110z, FIG. 1) suitable for offloading UEs based at least in part on the one or more measurement reports 216. In some aspects, the one or more measurement reports 216 may include a load level value of the proximate network entity.

Additionally, transmission power adjustment component 208 may be configured to identify at least one UE from the number of UEs to offload to a proximate small cell from the list of proximate small cells 210. For example, the small cell may form a list of proximate small cells based at least in part on a measurement report received from the UE. As an example, the proximate small cell list 210 may include small cell 110z (FIG. 1), which may be determined by small cell 110y (FIG. 1) to be a suitable small cell for offloading UE 120y (FIG. 1).

Further, in such aspects, transmission power adjustment component 208 may be configured to determine a relative adjustment in the transmission power value to each of the proximate small cells based at least in part on a reference signal received power (RSRP) for each of the candidate small cells based on the one or more measurement reports received from the UEs 120. That is, a transmission power adjustment value corresponding to each of the proximate small cells in the proximate small cell list 210 may be determined based on, for example, one or both of the one or more measurement reports 216 and the RSRP for each of the proximate small cells.

In some aspects, the list of proximate small cells 210 may include one or more proximate small cells sorted by corresponding load level values. As such, the small cell may select a proximate small cell suitable for offloading based on the corresponding load level value. For instance, the small cells in the proximate small cell list 210 may be sorted from a lowest load level to a highest load level. In other aspects, the small cells in the proximate small cell list 210 may be sorted from a highest load level to a lowest load level.

As such, power/resource management component 130 may be configured to identify and/or select a proximate small cell having a lowest load level for offloading one or more UEs located at, for example, an edge region, to the proximate small cell having the lowest load level. Moreover, in other aspects, the power adjustment may be limited to a particular transmission power range based on the initial transmission power setting.

In another aspect, transmission power adjustment component 208 may be configured to request a proximate small cell to adjust a transmission power level. For example, transmission power adjustment component 208 (e.g., of small cell 110y, FIG. 1) may be configured to request or otherwise instruct a proximate small cell (e.g., small cell 110z, FIG. 1) to increase its transmission power level from the first transmission power value 212 to the second transmission power value 214, when, in some aspects, the decrease in transmission power at the serving small cell failed to achieve an adequate level of load balancing.

That is, in such aspects, transmission power adjustment component 208 may be configured to determine whether the adjustment of the transmission power value of the serving small cell (e.g., small cell 110y, FIG. 1) from a first transmission value 212 to a second transmission value 214 resulted in load balancing between the network entity and one or more proximate network entities. In such aspects, the serving small cell (e.g., small cell 110y) may demonstrate a balanced load with respect to a proximate small cell (e.g., small cell 110z) when no single small cell is experiencing or otherwise includes a number of UEs that meet or exceed a high load threshold level value. As such, load balancing permits for serving small cell to offload at least one UE located at, for example, an edge region, to a proximate small cell.

In such aspects, transmission power adjustment component 208 may be configured to identify a suitable proximate small cell to request an increase in its transmission power based on its load level value and/or its power differential. Specifically, in order to select a proximate small cell to increase its transmission power, transmission power adjustment component 208 may determine that a load level value of the proximate small cell (e.g., small cell 110z) meets or is below is a load level threshold value. Additionally, transmission power adjustment component 208 may be configured to determine that a power differential level value of the proximate small cell meets or exceeds a power differential level threshold value.

Accordingly, based on the foregoing, transmission power adjustment component 208 may be configured to request a proximate small cell to adjust a transmission power level value. Further, for example, transmission power adjustment component 208 may be configured to omit a proximate small cell in which its UEs are receiving low throughput. Additionally, a small cell may request multiple small cells to conduct/perform the transmission power adjustment procedure described herein sequentially until a desired level of offload is achieved to proximate small cells. For example, serving small cell (e.g., small cell 110y, FIG. 1) may request a second proximate small cell to adjust its transmission power when offloading of UEs to a first proximate small cell did not result in an offload level value meeting or exceeding an offload threshold level value.

In further aspects, power/resource management component 130 may include power/resource management policy component 220, which may be configured to update a power/resource management policy corresponding to an adjustment of the transmission power level of the serving small cell and/or the proximate small cell. In other words, for example, power/resource management policy component 220 may be configured to update a power/resource management policy following an adjustment of one or more power management aspects (e.g., adjusting of its transmission power and/or requesting proximate small cell adjust transmission power). In other aspects, to facilitate the joint manner of the power and resource management aspects, power/resource management policy component 220 may be configured to evaluate the power adjustments made by the transmission power adjustment component 208 in order to determine whether a corresponding adjustment may be made to the small cell communication resources.

Specifically, to update its resource management policy, power/resource management policy component 220 may be configured to determine that at least one edge UE (e.g., UE 120y, FIG. 1) is not served by a proximate small cell (e.g., small cell 110z, FIG. 1). Further, power/resource management policy component 220 may be configured to adjust a resource partitioning level value at the serving small cell (e.g., small cell 110y) to a maximum available resource partitioning level value for permitting communication over an entire bandwidth to one or more UEs served by the serving small cell. In some aspects, the one or more UEs may include one or both edge UEs and non-edge UEs.

For instance, in such aspects, small cell 110y (FIG. 1), via power/resource management policy component 220, may be configured to disable soft-fractional frequency reuse (SFFR) and enable a reuse state during which a maximum transmission power may be provided on some or all data tones and/or an entire bandwidth is made available to all UEs when at least one neighbor/proximate small cell is not serving at least one cell edge UE.

In a further aspect, power/resource management policy component 220 may be configured to determine that a relative load level value of the small cell relative to the proximate small cell meets or exceeds a relative load level threshold value. Accordingly, power/resource management policy component 220 may be configured to adjust a partitioning of communication resources used for communication with one or more UEs.

For instance, in one aspect, power/resource management policy component 220 may be configured to adjust the partitioning of communication resources by adjusting at least one of a number of edge UEs and non-edge UEs such that a minimum service level value for UEs associated with the network entity meets or exceeds a minimum service level threshold value. Additionally, in another aspect, power/resource management policy component 220 may be configured to adjust the partitioning of communication resources by adjusting a transmission power level value on at least one data tone characteristic.

In an additional aspect, power/resource management policy component 220 may be configured to adjust the partitioning of communication resources by adjusting the resource partitioning level value at the serving small cell (e.g., small cell 110y) to the maximum available resource partitioning level value for permitting communication over an entire bandwidth to one or more UEs. In some aspects, the one or more UEs may include one or both of edge UEs and non-edge UEs.

For example, in such aspects, small cell 110y, via power/resource management policy component 220, may be configured to adjust the SFFR parameters when the relative load remains above a threshold level value. Specifically, power/resource management component 130 may adjust the parameters such that the ratio of cell edge UEs and cell edge UEs may be adapted or otherwise modified until a minimum service level is met for all UEs. Additionally, the transmission power of small cell 110y (FIG. 1) may be increased on all or substantially all data tones and/or the entire bandwidth may be made available for use to all UEs (e.g., edge UEs and non-edge UEs).

In additional aspects, to facilitate coordination among two or more small cells, power/resource management policy component 220 may be configured to send the updated power/resource management policy 224 of the small cell (e.g., small cell 110y, FIG. 1) to at least one proximate small cell (e.g., small cell 110z, FIG. 1) for updating a current power/resource management policy of the proximate small cell to an updated power/resource management policy 224. In such aspects, proximate small cell may then use the updated power/resource management policy of small cell 110y in its joint power and resource management procedures.

In some aspects, the power/resource features may be alternatively or interchangeably referred to as a power and/or resource features. For instance, the power/resource management component 130 may also be referred to as a power and/or resource management component. In such aspects, the power and/or resource management component may be configured to manage, in a joint and/or coordinated manner, one or both of the power and resource aspects of one or more small cells. In further aspects, the power and/or resource management component may be configured to perform the aspects described herein with respect to the power/resource management component 130.

As such, aspects described herein with respect to the power/resource management component 130, such as, but not limited to, the power/resource management policy, may be interchangeably and/or alternatively referred to as a power and/or management policy. Additionally, the power/resource partitioning characteristics 132 may be interchangeably and/or alternatively referred to as a power and/or resource partitioning characteristics. Further, the power/resource management component 130 may be interchangeably and/or alternatively referred to as a power and/or resource management procedure component.

Moreover, the power/resource management triggering component 202 may be interchangeably and/or alternatively referred to as a power and/or resource management triggering component. In addition, the power/resource management policy component 220 may be interchangeably and/or alternatively referred to as a power and/or resource management policy component. In other aspects, the updated power/resource management policy 224 may be interchangeably and/or alternatively referred to as an updated power and/or resource management policy.

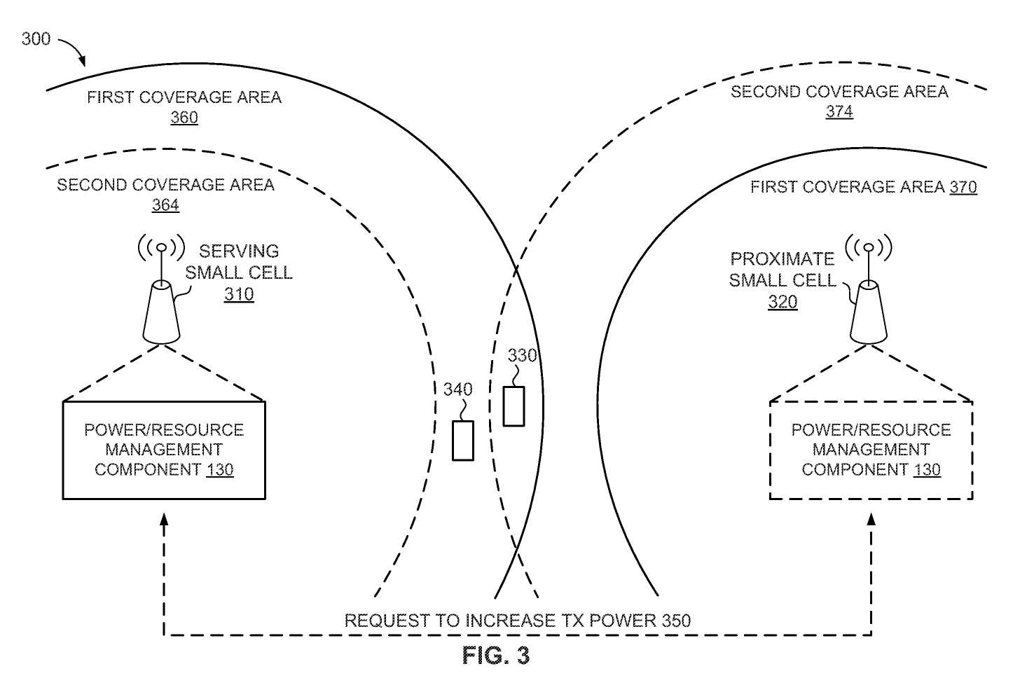

Referring to FIG. 3, a conceptual diagram illustrates an example communication system 300 for joint power management and resource management at one or both of serving small cell 310 and proximate small cell 320 in accordance with power/resource management component 130. In such aspects, power/resource management component 130 may include or comprise the aspects described herein with respect to FIGS. 1 and 2.

Specifically, communication system 300 may include serving small cell 310 and proximate small cell 320, each of which may include a corresponding communication coverage area. For instance, serving small cell 310 may include a first coverage area 360. Additionally, proximate small cell 320 may include a first coverage area 370 which may be smaller in coverage area than the first coverage area 360 of the serving small cell 310. Further, one or both of serving small cell 310 and proximate small cell 320 may include power/resource management component 130.

In an aspect, serving small cell 310 may determine or otherwise detect, via power/resource management component 130, a power/resource management triggering condition for triggering an adjustment of a transmission power of one or both of the serving small cell 310 and the proximate small cell 320. For instance, serving small cell 310 may be experiencing a high load as a result of serving UEs 330 and 340. In some aspects, serving small cell 310 may initially attempt to balance the load by offloading one or both of UEs 330 and 340 to proximate small cell 320.

For example, serving small cell 310 may decrease its transmission power from a first transmission power value to a second transmission power value smaller than the first transmission power value. By doing so, serving small cell's 310 corresponding coverage area may be decreased from the first coverage area 360 to the second coverage area 364. When such a decrease is made to the transmission power of serving small cell 310, at least UE 330 may be offloaded from serving small cell 310, thereby alleviating the congestion at serving small cell and potentially balancing the load level. However, in some cases, the serving small cell's 310 adjustment in transmission power may be insufficient to adequately balance is load level.

As such, serving small cell 310 may, in some aspects, send a request or instruction to proximate small cell 320 to increase its transmission power (e.g., request to increase transmission power 350. Upon receiving the request or instruction, proximate small cell 320 may increase its coverage area from the first coverage area 370 to a second coverage area 374 larger than the first coverage area 370. Consequently, at least UE 330 may be offloaded from serving small cell 310 to proximate small cell 320, thereby shifting a load amount from serving small cell 310 to proximate small cell 320.

Upon performing one or more power adjustment procedures, either or both at serving small cell 310 and proximate small cell 320, serving small cell 310 may update the power/resource management policy. For example, the updated power/resource management policy may reflect or include the adjustments made to the transmission power. Additionally, the updated power/resource management policy may include adjustments made to the resources at the serving small cell 310, as described herein with respect to FIG. 2. The updated power/resource management policy may be sent to one or more proximate small cells including proximate small cell 320 to facilitate coordination in power and resource management among two or more small cells.

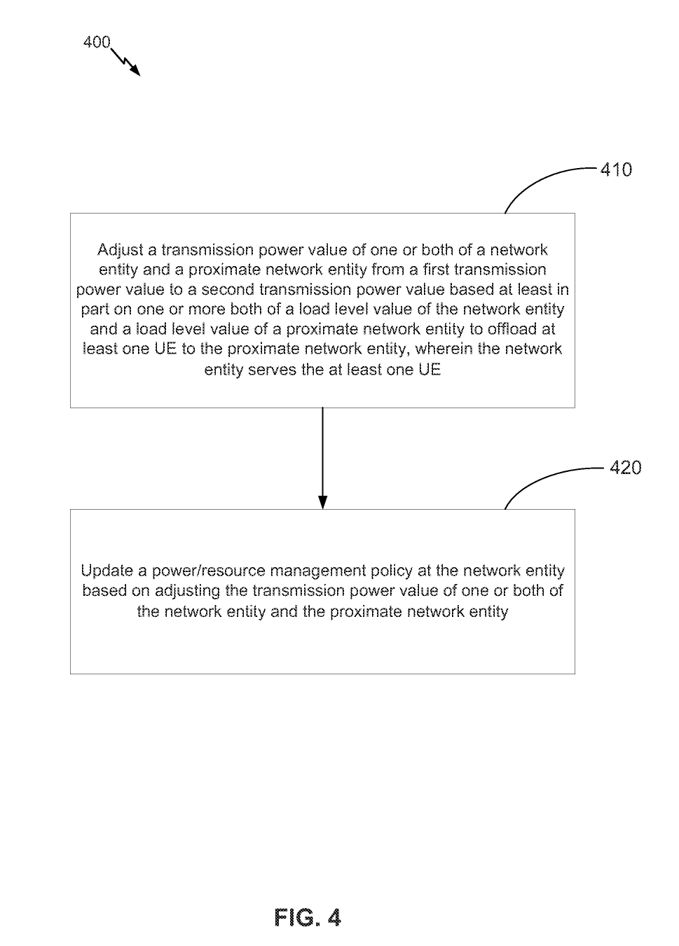

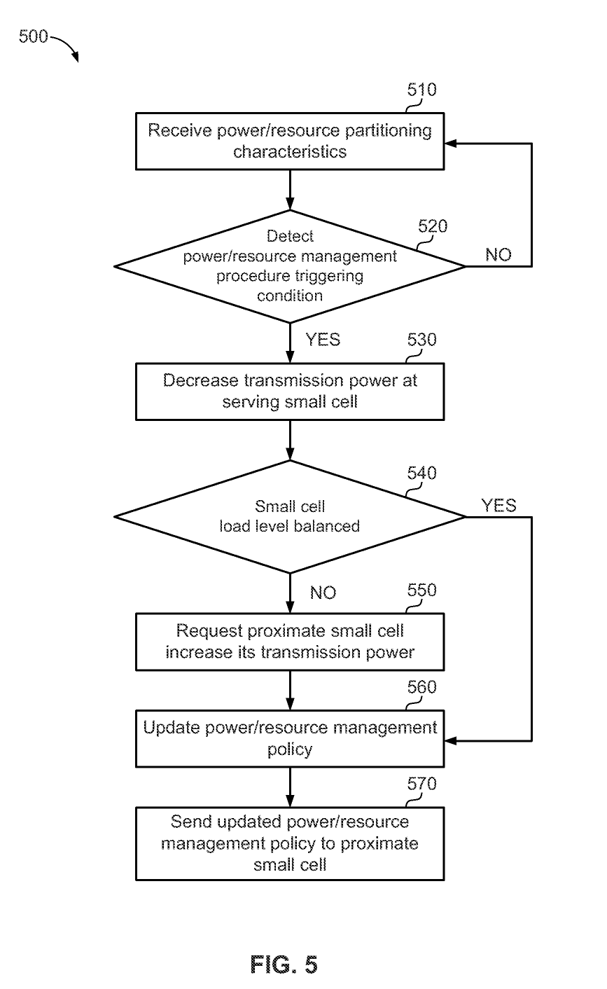

Referring to FIGS. 4 and 5, the methods are shown and described as a series of acts for purposes of simplicity of explanation. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

Referring to FIG. 4, in an operational aspect, a network entity such as small cell 110y (FIG. 1) may perform one aspect of a method 400 for adjusting a transmission power value and updating power and/or resource management policies according to the power/resource management component 130 (FIGS. 1 and 2).

In an aspect, at block 410, method 500 may adjust a transmission power value of one or both of a network entity and a proximate network entity from a first transmission power value to a second transmission power value based at least in part on one or both of a load level value of the network entity and a load level value of a proximate network entity to offload at least one UE to the proximate network entity. For example, as described herein, power/resource management component 130 (FIGS. 1 and 2) may execute transmission power adjustment component 208 (FIG. 2) to adjust a transmission power value of one or both of a network entity (e.g., small cell 110y) and a proximate network entity (e.g., small cell 110z) from a first transmission power value 212 to a second transmission power value 214 based at least in part on one or both of a load level value of the network entity and a load level value of a proximate network entity to offload at least one UE 120y to the proximate network entity (e.g., small cell 110z). In some aspects, the network entity may serve the at least one UE.

At block 420, method 400 may update a power/resource management policy at the network entity based on adjusting the transmission power value of one or both of the network entity and the proximate network entity. For example, as described herein, power/resource management component 130 (FIGS. 1 and 2) may execute power/resource management policy component 220 (FIG. 2) to update a power/resource management policy 224 (FIG. 2) at the network entity (e.g., small cell 110y) based on adjusting the transmission power value of one or both of the network entity and the proximate network entity.

Referring to FIG. 5, in an operational aspect, a network entity such as small cell 110y (FIG. 1) may perform one aspect of method 500 for adjusting a transmission power value and updating power and/or resource management policies according to the power/resource management component 130 (FIGS. 1 and 2).

At block 510, method 500 may receive power/resource partitioning characteristics. For example, as described herein, small cell 110y (FIG. 1) may execute power/resource management component 130 (FIGS. 1 and 2) to receive power/resource partitioning characteristics from one or more proximate small cells (e.g., proximate small cell 110z). Further, at block 520, method 500 may detect power/resource management procedure triggering condition. For instance, as described herein, power/resource management component 130 (FIGS. 1 and 2) may execute power/resource management triggering component 202 (FIG. 2) to detect or otherwise determine power/resource management procedure triggering condition 206 for triggering an adjustment of the transmission power of one or both of a serving small cell and a proximate small cell. Method may return to block 510 and continue receiving power/resource partitioning characteristics.

At block 530, method 500 may decrease a transmission power at the serving small cell, when, for instance, a power/resource management procedure triggering condition is detected at block 520. For example, as described herein, power/resource management component 130 (FIGS. 1 and 2) may execute transmission power adjustment component 208 (FIG. 1) to decrease the transmission power of the serving small cell from a first transmission value 212 (FIG. 2) to a second transmission value 214 (FIG. 2).

Additionally, at block 540, method 500 may determine whether the small cell load is balanced. For example, a determination may be made as to whether the decrease in the transmission power at the serving small cell results in a corresponding decrease the load level at the serving small cell. Specifically, method 500 may determine whether a load level value at the serving small cell after a decrease in its transmission power meets and/or drops below a balanced load threshold level. In such aspects, as described herein, power/resource management component 130 (FIGS. 1 and 2) may execute transmission power adjustment component 208 to determine whether the small cell load is balanced. Method 540 may proceed to block 560 if the load level at the small cell is determined to be balanced.

Otherwise, at block 550, method 500 may request a proximate small cell to increase its transmission power. For instance, in order to further assist serving small cell in decreasing its load level, and to balance the overall load in the communication network, proximate small cell may increase its transmission power from a first transmission value to a second transmission value higher than the first transmission value. In such aspects, as described herein, power/resource management component 130 (FIGS. 1 and 2) may execute transmission power adjustment component 208 (FIG. 2) to request a proximate small cell (e.g., small cell 110z, FIG. 1) to increase its transmission power from a first transmission power value 212 (FIG. 2) to a second transmission power value 214 (FIG. 2).

At block 560, method 500 may update the power/resource management policy, for example, at the serving small cell. Specifically, following an adjustment of a transmission power at one or both of the serving small cell and the proximate small cell, serving small cell may engage in a resource management procedure and update its power/resource management policy, as described herein. As further described herein, power/resource management component 130 (FIGS. 1 and 2) may execute power/resource management policy component 220 (FIG. 2) to update a power/resource management policy 224 (FIG. 2) at the serving small cell (e.g., small cell 110y) based on adjusting the transmission power value of one or both of the serving small cell 110y (FIG. 1) and the proximate small cell 110z (FIG. 1).

Moreover, at block 570, method 500 may send the updated power/resource management policy to the proximate small cell. For instance, power/resource management component 130 (FIGS. 1 and 2) may execute power/resource management policy component 220 (FIG. 2) to send the updated power/resource management policy 224 (FIG. 2) to the proximate small cell 110z (FIG. 1). In such aspects, the updated power/resource management policy may enable or otherwise permit coordination with respect to power and communication resources among two or more small cells.

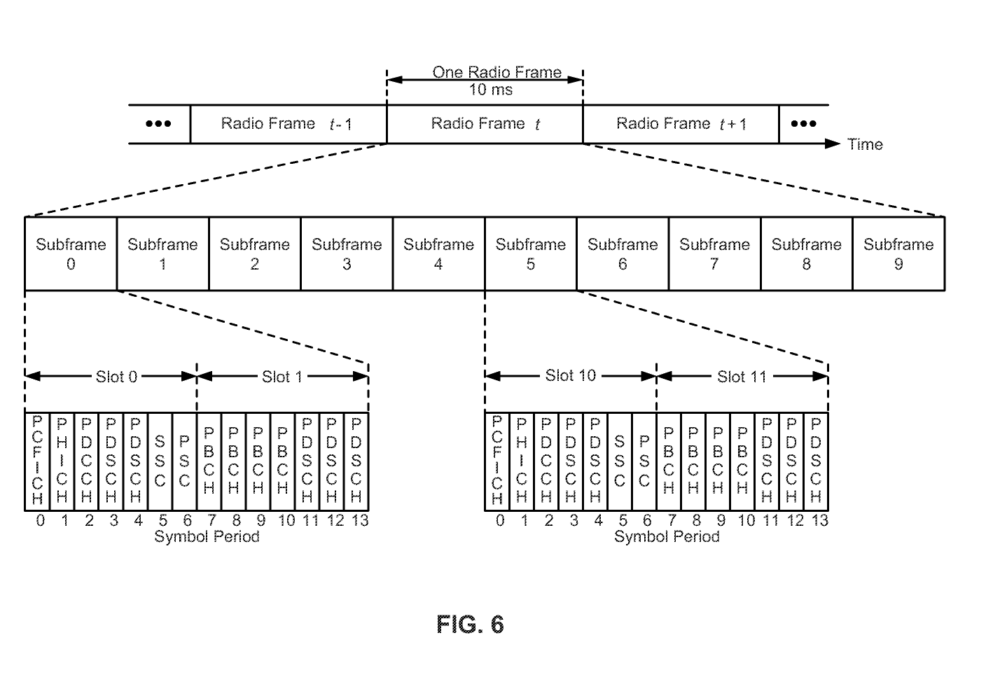

FIG. 6 is a block diagram conceptually illustrating an example of a down link frame structure in a telecommunications system in accordance with an aspect of the present disclosure. The transmission timeline for the downlink may be partitioned into units of radio frames. Each radio frame may have a predetermined duration (e.g., 10 milliseconds (ms)) and may be partitioned into 10 sub-frames with indices of 0 through 9. Each sub-frame may include two slots. Each radio frame may thus include 20 slots with indices of 0 through 19. Each slot may include L symbol periods, e.g., 7 symbol periods for a normal cyclic prefix (as shown in FIG. 2) or 14 symbol periods for an extended cyclic prefix (not shown). The 2L symbol periods in each sub-frame may be assigned indices of 0 through 2L-1. The available time frequency resources may be partitioned into resource blocks. Each resource block may cover N subcarriers (e.g., 12 subcarriers) in one slot.

In LTE for example, an eNodeB may send a primary synchronization signal (PSS) and a secondary synchronization signal (SSS) for each cell in the coverage area of the eNodeB. The primary synchronization signal (PSS) and secondary synchronization signal (SSS) may be sent in symbol periods 6 and 5, respectively, in each of sub-frames 0 and 5 of each radio frame with the normal cyclic prefix, as shown in FIG. 6. The synchronization signals may be used by UEs for cell detection and acquisition. The eNodeB may send system information in a Physical Broadcast Channel (PBCH) in symbol periods 0 to 3 of slot 1 of sub-frame 0.

The eNodeB may send information in a Physical Control Format Indicator Channel (PCFICH) in only a portion of the first symbol period of each sub-frame, although depicted in the entire first symbol period in FIG. 6. The PCFICH may convey the number of symbol periods (M) used for control channels, where M may be equal to 1, 2 or 3 and may change from sub-frame to sub-frame. M may also be equal to 4 for a small system bandwidth, e.g., with less than 10 resource blocks. In the example shown in FIG. 2, M=3. The eNodeB may send information in a Physical HARQ Indicator Channel (PHICH) and a Physical Downlink Control Channel (PDCCH) in the first M symbol periods of each sub-frame (M=3 in FIG. 2). The PHICH may carry information to support hybrid automatic retransmission (HARQ). The PDCCH may carry information on uplink and downlink resource allocation for UEs and power control information for uplink channels. Although not shown in the first symbol period in FIG. 6, it may be understood that the PDCCH and PHICH are also included in the first symbol period.

Similarly, the PHICH and PDCCH are also both in the second and third symbol periods, although not shown that way in FIG. 6. The eNodeB may send information in a Physical Downlink Shared Channel (PDSCH) in the remaining symbol periods of each sub-frame. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNodeB may send the PSS, SSS and PBCH around the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to specific UEs in specific portions of the system bandwidth. The eNodeB may send the PSS, SSS, PBCH, PCFICH and PHICH in a broadcast manner to all UEs in the coverage area. The eNodeB may send the PDCCH in a unicast manner to specific UEs in the coverage area. The eNodeB may also send the PDSCH in a unicast manner to specific UEs in the coverage area.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNodeB may send the PDCCH to the UE in any of the combinations that the UE will search.

A UE may be within the coverage areas of multiple eNodeBs. One of these eNodeBs may be selected to serve the UE. The serving eNodeB may be selected based on various criteria such as received power, path loss, signal-to-noise ratio (SNR), etc.

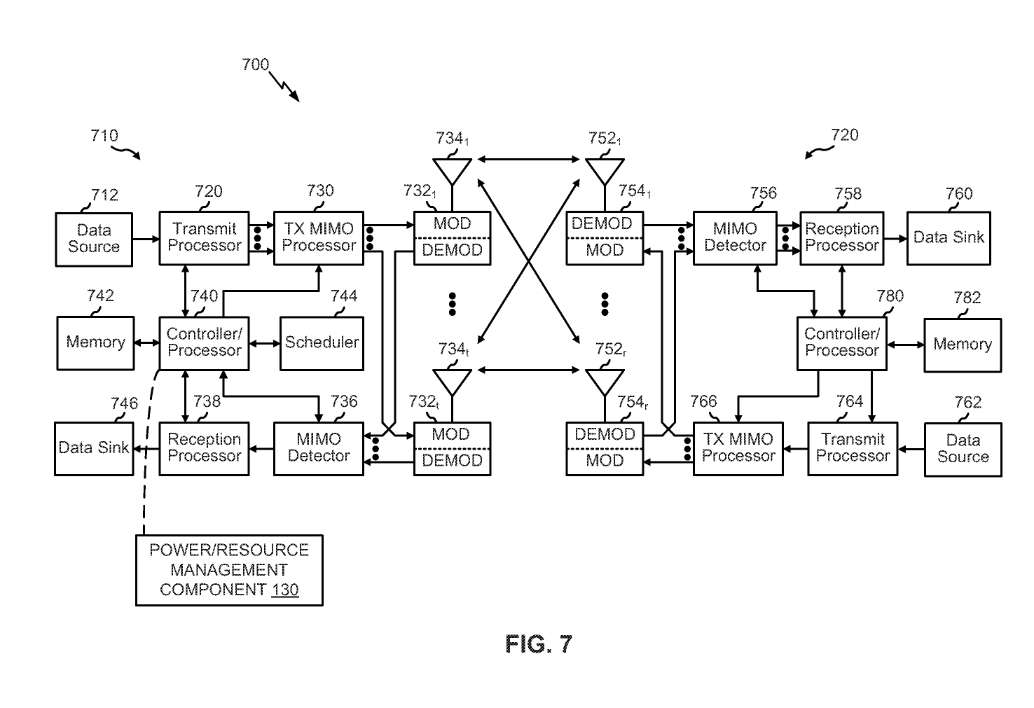

FIG. 7 is a block diagram conceptually illustrating an exemplary eNodeB 710 and an exemplary UE 720 configured in accordance with an aspect of the present disclosure. For example, the base station/eNodeB 710 and the UE 720, as shown in FIG. 7, may be one of the base stations/eNodeBs and one of the UEs in FIG. 1, including the network entity/small cell 110y including power/resource management component 130. The base station 710 may be equipped with antennas 734₁₋ₜ, and the UE 720 may be equipped with antennas 752₁₋ᵣ, wherein t and r are integers greater than or equal to one.

At the base station 710, a base station transmit processor 720 may receive data from a base station data source 712 and control information from a base station controller/processor 740. The control information may be carried on the PBCH, PCFICH, PHICH, PDCCH, etc. The data may be carried on the PDSCH, etc. The base station transmit processor 720 may process (e.g., encode and symbol map) the data and control information to obtain data symbols and control symbols, respectively. The base station transmit processor 720 may also generate reference symbols, e.g., for the PSS, SSS, and cell-specific reference signal (RS).

A base station transmit (TX) multiple-input multiple-output (MIMO) processor 730 may perform spatial processing (e.g., precoding) on the data symbols, the control symbols, and/or the reference symbols, if applicable, and may provide output symbol streams to the base station modulators/demodulators (MODs/DEMODs) 732₁₋ₜ. Each base station modulator/demodulator 732 may process a respective output symbol stream (e.g., for OFDM, etc.) to obtain an output sample stream. Each base station modulator/demodulator 732 may further process (e.g., convert to analog, amplify, filter, and upconvert) the output sample stream to obtain a downlink signal. Downlink signals from modulators/demodulators 732₁₋ₜ may be transmitted via the antennas 734₁₋ₜ, respectively.

At the UE 720, the UE antennas 752₁₋ᵣ may receive the downlink signals from the base station 710 and may provide received signals to the UE modulators/demodulators (MODs/DEMODs) 754₁₋ᵣ, respectively. Each UE modulator/demodulator 754 may condition (e.g., filter, amplify, downconvert, and digitize) a respective received signal to obtain input samples. Each UE modulator/demodulator 754 may further process the input samples (e.g., for OFDM, etc.) to obtain received symbols. A UE MIMO detector 756 may obtain received symbols from all the UE modulators/demodulators 754₁₋ᵣ, and perform MIMO detection on the received symbols if applicable, and provide detected symbols. A UE reception processor 758 may process (e.g., demodulate, deinterleave, and decode) the detected symbols, provide decoded data for the UE 720 to a UE data sink 760, and provide decoded control information to a UE controller/processor 780.

On the uplink, at the UE 720, a UE transmit processor 764 may receive and process data (e.g., for the PUSCH) from a UE data source 762 and control information (e.g., for the PUCCH) from the UE controller/processor 780. The UE transmit processor 764 may also generate reference symbols for a reference signal. The symbols from the UE transmit processor 764 may be precoded by a UE TX MIMO processor 766 if applicable, further processed by the UE modulator/demodulators 754₁₋ᵣ (e.g., for SC-FDM, etc.), and transmitted to the base station 710. At the base station 710, the uplink signals from the UE 720 may be received by the base station antennas 734, processed by the base station modulators/demodulators 732, detected by a base station MIMO detector 736 if applicable, and further processed by a base station reception processor 738 to obtain decoded data and control information sent by the UE 720. The base station reception processor 738 may provide the decoded data to a base station data sink 746 and the decoded control information to the base station controller/processor 740.

The base station controller/processor 740 and the UE controller/processor 780 may direct the operation at the base station 710 and the UE 720, respectively. The base station controller/processor 740 and/or other processors and modules at the base station 710 may perform or direct, e.g., the execution of various processes for the techniques described herein. The UE controller/processor 780 and/or other processors and modules at the UE 720 may also perform or direct, e.g., the execution of the functional blocks illustrated in FIGS. 4 and 5 and/or other processes for the techniques described herein. The base station memory 742 and the UE memory 782 may store data and program codes for the base station 710 and the UE 720, respectively. A scheduler 744 may schedule UEs 720 for data transmission on the downlink and/or uplink.

In one configuration, the base station 710 may include means for generating a compact Downlink Control Information (DCI) for at least one of uplink (UL) or downlink (DL) transmissions, wherein the compact DCI comprises a reduced number of bits when compared to certain standard DCI formats; and means for transmitting the DCI. In one aspect, the aforementioned means may be the base station controller/processor 740, the base station memory 742, the base station transmit processor 720, the base station modulators/demodulators 732, and the base station antennas 734 configured to perform the functions recited by the aforementioned means. In another aspect, the aforementioned means may be a module or any apparatus configured to perform the functions recited by the aforementioned means.

In one configuration, the UE 720 may include means for receiving compact Downlink Control Information (DCI) for at least one of uplink (UL) or downlink (DL) transmissions, wherein the DCI comprises a reduced number of bits of a standard DCI format; and means for processing the DCI. In one aspect, the aforementioned means may be the UE controller/processor 380, the UE memory 782, the UE reception processor 758, the UE MIMO detector 756, the UE modulators/demodulators 754, and the UE antennas 752 configured to perform the functions recited by the aforementioned means. In another aspect, the aforementioned means may be a module or any apparatus configured to perform the functions recited by the aforementioned means.

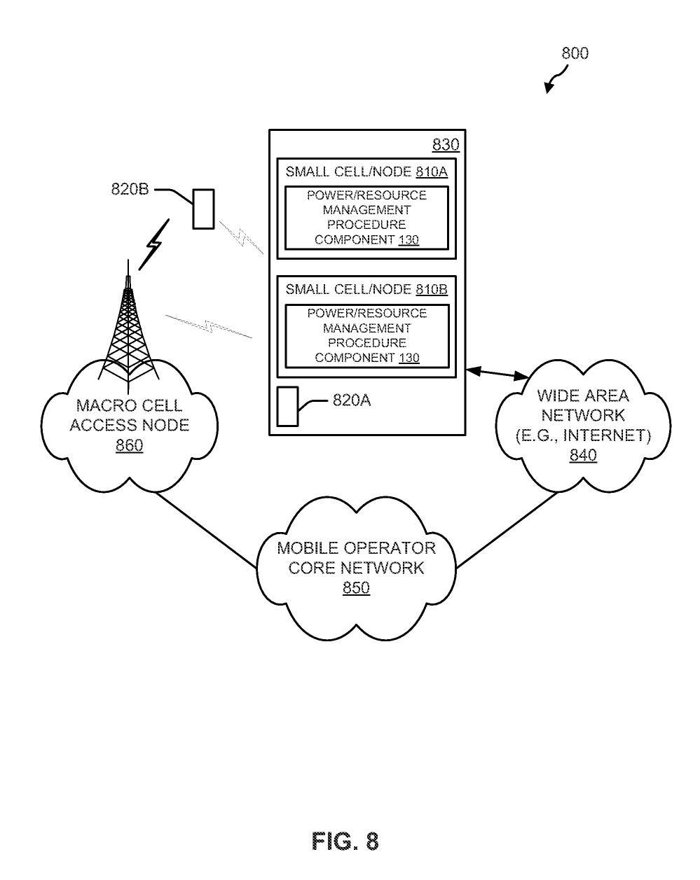

FIG. 8 illustrates an exemplary communication system 800 where one or more small cells are deployed within a network environment. Specifically, the system 800 includes multiple small cells 810 (e.g., small cells or HNB 810A and 810B) installed in a relatively small scale network environment (e.g., in one or more user residences 830), wherein the small cells 810 may be the same as or similar to small cell 110y (FIG. 1) including power/resource management component 130 (FIG. 1). Each small cell 810 may be coupled to a wide area network 840 (e.g., the Internet) and a mobile operator core network 850 via a router, a cable modem, a wireless link, or other connectivity means (not shown).

In an aspect, each small cell 810 may be configured to serve associated access terminals 820 (e.g., access terminal 820A) and, optionally, alien access terminals 820 (e.g., access terminal 820B), both of which may be the same as or similar to UE 120 (FIG. 1). In other words, access to small cells 810 may be restricted whereby a given access terminal 820 may be served by a set of designated (e.g., home) small cell(s) 810 but may not be served by any non-designated small cells 810 (e.g., a neighbor's small cell 810).

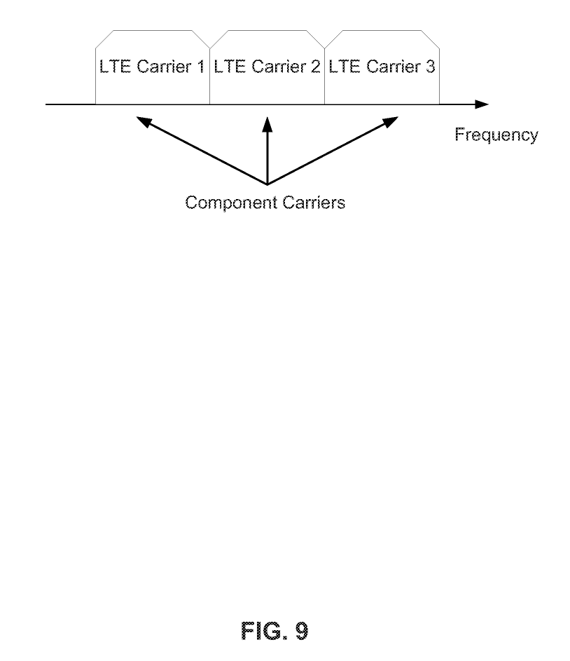

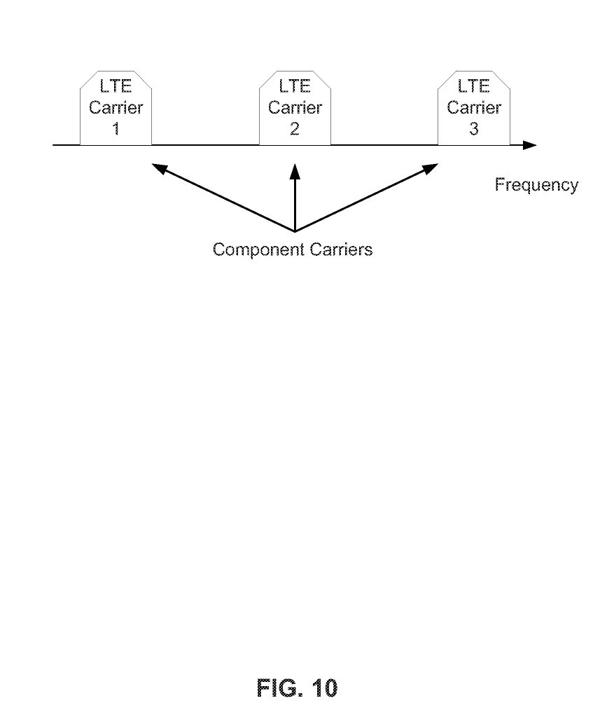

UEs (e.g., LTE-Advanced enabled UEs) may use spectrum of up to 20 MHz bandwidths allocated in a carrier aggregation of up to a total of 100 MHz (5 component carriers) used for transmission and reception. For the LTE-Advanced enabled wireless communication systems, two types of carrier aggregation (CA) methods have been proposed, continuous CA and non-continuous CA, which are illustrated in FIGS. 9 and 10, respectively. Continuous CA occurs when multiple available component carriers are adjacent to each other (as illustrated in FIG. 9). On the other hand, non-continuous CA occurs when multiple non-adjacent available component carriers are separated along the frequency band (as illustrated in FIG. 10). It should be understood that any one or more network entities (e.g., eNodeBs), including network entity 110, illustrated in FIG. 1 may communicate or facilitate communication according to the aspects set forth with regard to FIGS. 9 and 10.

Both non-continuous and continuous CA may aggregate multiple component carriers to serve a single unit of LTE-Advanced UEs. In various examples, the UE operating in a multicarrier system (also referred to as carrier aggregation) is configured to aggregate certain functions of multiple carriers, such as control and feedback functions, on the same carrier, which may be referred to as a “primary carrier.” The remaining carriers that depend on the primary carrier for support may be referred to as “associated secondary carriers.” For example, the UE may aggregate control functions such as those provided by the optional dedicated channel (DCH), the nonscheduled grants, a physical uplink control channel (PUCCH), and/or a physical downlink control channel (PDCCH).

LTE-A standardization may require carriers to be backward-compatible, to enable a smooth transition to new releases. However, backward-compatibility may require the carriers to continuously transmit common reference signals (CRS), also may be referred to as (cell-specific reference signals) in every subframe across the bandwidth. Most cell site energy consumption may be caused by the power amplifier since the cell remains on even when only limited control signalling is being transmitted, causing the amplifier to continuously consume energy.

CRS were introduced in release 8 of LTE standard and may be referred to as LTE's most basic downlink reference signal. For example, CRS may be transmitted in every resource block in the frequency domain and in every downlink subframe. CRS in a cell can be for one, two, or four corresponding antenna ports. CRS may be used by remote terminals to estimate channels for coherent demodulation. A new carrier type may allow temporarily switching off of cells by removing transmission of CRS in four out of five subframes. This reduces power consumed by the power amplifier. It also may reduce the overhead and interference from CRS since the CRS won't be continuously transmitted in every subframe across the bandwidth. In addition, the new carrier type may allow the downlink control channels to be operated using UE-specific demodulation reference symbols. The new carrier type might be operated as a kind of extension carrier along with another LTE/LTE-A carrier or alternatively as standalone non-backward compatible carrier.

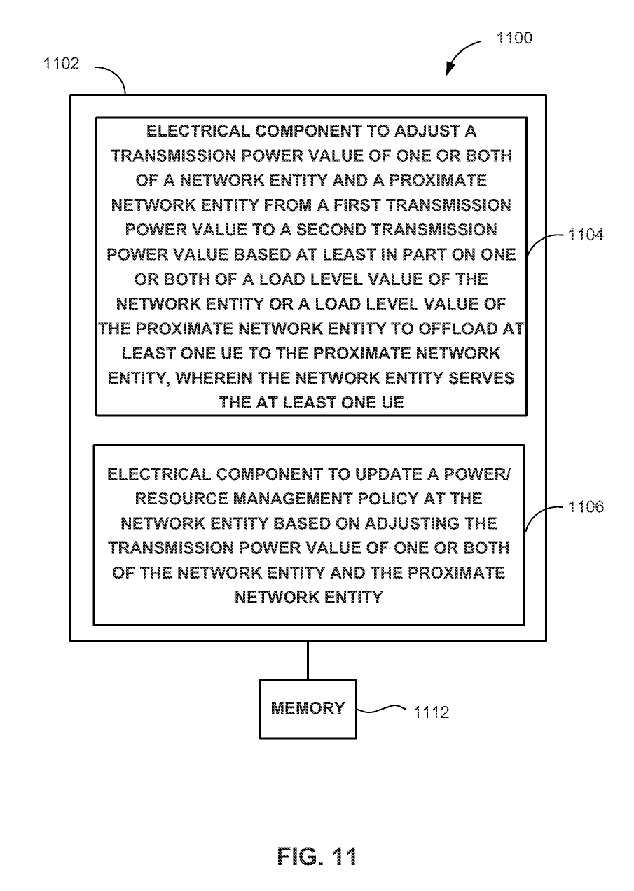

Referring to FIG. 11, an example system 1100 for power and/or resource management may operate according to the aspects of the power/resource management component 130 (FIGS. 1 and 2) and the corresponding methods (FIGS. 4 and 5).

For example, system 1100 can reside at least partially within an access point, for example, small cell 110y (FIG. 1) including power/resource management component 130. It is to be appreciated that system 1100 is represented as including functional blocks, which can be functional blocks that represent functions implemented by a processor, software, or combination thereof (for example, firmware). System 1100 includes a logical grouping 1102 of electrical components that can act in conjunction.

For instance, logical grouping 1102 may include an electrical component 1104 to adjust a transmission power value of one or both of a network entity and a proximate network entity from a first transmission power value to a second transmission power value based at least in part on one or both of a load level value of the network entity and a load level value of a proximate network entity to offload at least one UE to the proximate network entity, wherein the network entity serves the at least one UE. For example, in an aspect, electrical component 1104 may include power/resource management component 130 (FIGS. 1 and 2). Further, logical grouping 1102 may include an electrical component 1106 to update a power/resource management policy at the network entity based on adjusting the transmission power value of one or both of the network entity and the proximate network entity. For example, in an aspect, electrical component 1106 may power/resource management component 130 (FIGS. 1 and 2).

Additionally, system 1100 can include a memory 1112 that retains instructions for executing functions associated with the electrical components 1104 and/or 1106, stores data used or obtained by the electrical components 1104, and/or 1106, etc. While shown as being external to memory 1112, it is to be understood that one or more of the electrical components 1104, and/or 1106 may exist within memory 1112. In one example, electrical components 1104, and/or 1106 can comprise at least one processor, or each electrical component 1104, and/or 1106 can be a corresponding module of at least one processor. Moreover, in an additional or alternative example, electrical components 1104, and/or 1106 can be a computer program product including a computer readable medium, where each electrical component 1104, and/or 1106 may be corresponding code.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of communication, comprising:
adjusting a transmission power value of one or both of a network entity and a proximate network entity from a first transmission power value to a second transmission power value based at least in part on one or both of a load level value of the network entity and a load level value of the proximate network entity to offload at least one user equipment (UE) to the proximate network entity, wherein the network entity serves the at least one UE; and
updating a power/resource management policy at the network entity based on adjusting the transmission power value of one or both of the network entity and the proximate network entity.

2. The method of claim 1, wherein adjusting the transmission power value of one or both of the network entity and the proximate network entity comprises decreasing the transmission power value of the network entity from the first transmission value to the second transmission value.

3. The method of claim 2, wherein decreasing the transmission power value of the network entity comprises:
receiving one or more measurement reports from a number of UEs located at an edge region of the network entity, wherein the one or more measurement reports include the load level value of the proximate network entity;
forming a list of proximate network entities based at least in part on the one or more measurement reports; and
identifying the at least one UE from the number of UEs to offload to the proximate network entity selected from the list of proximate network entities.

4. The method of claim 3, further comprising determining a transmission power adjustment value corresponding to each of the proximate network entities in the list of proximate network entities based at least in part on one or both of the one or more measurement reports and a reference signal received power for each of the proximate network entities.

5. The method of claim 4, wherein the list of proximate network entities comprises one or more proximate network entities sorted by corresponding load level values from a lowest load level value to a highest load level value.

6. The method of claim 1, wherein adjusting the transmission power value of one or both of the network entity and the proximate network entity comprises requesting the proximate network entity to increase its transmission power level value from the first transmission power value to the second transmission power value.

7. The method of claim 6, wherein requesting the proximate network entity to increase its transmission power level value comprises:
determining that the load level value of the proximate network entity meets or is less than a load level threshold value; and
determining that a power differential level value of the proximate network entity meets or exceeds a power differential level threshold value.

8. The method of claim 1, wherein updating the power/resource management policy at the network entity comprises:
determining that at least one edge UE is not served by the proximate network entity; and
adjusting a resource partitioning level value at the network entity to a maximum available resource partitioning level value for permitting communication over an entire bandwidth to one or more UEs served by the network entity, wherein the one or more UEs comprise one or both of edge UEs and non-edge UEs.

9. The method of claim 1, wherein the updating the power/resource management policy at the network entity comprises:
determining that a relative load level value of the network entity relative to the proximate network entity meets or exceeds a relative load level threshold value; and
adjusting a partitioning of communication resources used for communication with one or more UEs.

10. The method of claim 9, wherein adjusting the partitioning of communication resources comprises one or more of:
adjusting at least one of a number of edge UEs and non-edge UEs such that a minimum service level value for UEs associated with the network entity meets or exceeds a minimum service level threshold value;
adjusting a transmission power level value on at least one data tone characteristic; and
adjusting the resource partitioning level value at the network entity to a maximum available resource partitioning level value for permitting communication over an entire bandwidth to one or more UEs, wherein the one or more UEs comprise one or both of edge UEs and non-edge UEs.

11. The method of claim 1, further comprising sending the updated power/resource management policy of the network entity to the proximate network entity for updating a power/resource management policy of the proximate network entity.

12. The method of claim 1, further comprising receiving one or more power/resource partitioning characteristics from the proximate network entity, wherein the one or more power/resource partitioning characteristics comprise one or more of a load level value, a number of edge UEs, a resource management status, a transmission power value, and a minimum throughput value.

13. The method of claim 12, further comprising determining a power/resource management procedure triggering condition for triggering an adjustment of the transmission power value of one or both of the network entity and the proximate network entity based on the one or more power/resource partitioning characteristics.

14. The method of claim 13, wherein determining the power/resource management procedure triggering condition comprises one or both of:
determining that a number of high demand UEs meets or exceeds a high demand UE load threshold value; and
determining that a number of reduced communication quality UEs meets or is less than a reduced communication quality UE threshold value.

15. A computer program product, comprising:
a computer-readable medium, including:
at least one instruction executable to cause a computer to adjust a transmission power value of one or both of a network entity and a proximate network entity from a first transmission power value to a second transmission power value based at least in part on one or both of a load level value of the network entity and a load level value of the proximate network entity to offload at least one user equipment (UE) to the proximate network entity, wherein the network entity serves the at least one UE; and
at least one instruction executable to cause the computer to update a power/resource management policy at the network entity based on adjusting the transmission power value of one or both of the network entity and the proximate network entity.

16. An apparatus for communication, comprising:
means for adjusting a transmission power value of one or both of a network entity and a proximate network entity from a first transmission power value to a second transmission power value based at least in part on one or both of a load level value of the network entity and a load level value of the proximate network entity to offload at least one user equipment (UE) to the proximate network entity, wherein the network entity serves the at least one UE; and
means for updating a power/resource management policy at the network entity based on adjusting the transmission power value of one or both of the network entity and the proximate network entity.

17. An apparatus for communication, comprising:
a memory storing executable instructions; and
a processor in communication with the memory, wherein the processor is configured to execute the instructions to:
adjust a transmission power value of one or both of a network entity and a proximate network entity from a first transmission power value to a second transmission power value based at least in part on one or both of a load level value of the network entity and a load level value of the proximate network entity to offload at least one user equipment (UE) to the proximate network entity, wherein the network entity serves the at least one UE; and
update a power/resource management policy at the network entity based on adjusting the transmission power value of one or both of the network entity and the proximate network entity.

18. The apparatus of claim 17, wherein to adjust the transmission power value of one or both of the network entity and the proximate network entity, the processor is further configured to execute the instructions to decrease the transmission power value of the network entity from the first transmission value to the second transmission value.

19. The apparatus of claim 18, wherein to decrease the transmission power value of the network entity, the processor is further configured to execute the instructions to:
receive one or more measurement reports from a number of UEs located at an edge region of the network entity, wherein the one or more measurement reports include the load level value of the proximate network entity;
form a list of proximate network entities based at least in part on the one or more measurement reports; and
identify the at least one UE from the number of UEs to offload to the proximate network entity selected from the list of proximate network entities.

20. The apparatus of claim 19, wherein the processor is further configured to execute the instructions to determine a transmission power adjustment value corresponding to each of the proximate network entities in the list of proximate network entities based at least in part on one or both of the one or more measurement reports and a reference signal received power for each of the proximate network entities.

21. The apparatus of claim 20, wherein the list of proximate network entities comprises one or more proximate network entities sorted by corresponding load level values from a lowest load level value to a highest load level value.

22. The apparatus of claim 17, wherein to adjust the transmission power value of one or both of the network entity and the proximate network entity, the processor is further configured to execute the instructions to request the proximate network entity to increase its transmission power level value from the first transmission power value to the second transmission power value.

23. The apparatus of claim 22, wherein to request the proximate network entity to increase its transmission power level value, the processor is further configured to execute the instructions to:
determine that the load level value of the proximate network entity meets or is less than a load level threshold value; and
determine that a power differential level value of the proximate network entity meets or exceeds a power differential level threshold value.

24. The apparatus of claim 17, wherein to update the power/resource management policy at the network entity, the processor is further configured to execute the instructions to:
determine that at least one edge UE is not served by the proximate network entity; and
adjust a resource partitioning level value at the network entity to a maximum available resource partitioning level value for permitting communication over an entire bandwidth to one or more UEs served by the network entity, wherein the one or more UEs comprise one or both of edge UEs and non-edge UEs.

25. The apparatus of claim 17, wherein to update the power/resource management policy at the network entity, the processor is further configured to execute the instructions to:
determine that a relative load level value of the network entity relative to the proximate network entity meets or exceeds a relative load level threshold value; and
adjust a partitioning of communication resources used for communication with one or more UEs.

26. The apparatus of claim 25, wherein to adjust the partitioning of communication resources, the processor is further configured to execute one or more of the instructions to:
adjust at least one of a number of edge UEs and non-edge UEs such that a minimum service level value for UEs associated with the network entity meets or exceeds a minimum service level threshold value;
adjust a transmission power level value on at least one data tone characteristic; and
adjust the resource partitioning level value at the network entity to a maximum available resource partitioning level value for permitting communication over an entire bandwidth to one or more UEs, wherein the one or more UEs comprise one or both of edge UEs and non-edge UEs.

27. The apparatus of claim 17, wherein the processor is further configured to execute the instructions to send the updated power/resource management policy of the network entity to the proximate network entity for updating a power/resource management policy of the proximate network entity.

28. The apparatus of claim 17, wherein the processor is further configured to execute the instructions to receive one or more power/resource partitioning characteristics from the proximate network entity, wherein the one or more power/resource partitioning characteristics comprise one or more of a load level value, a number of edge UEs, a resource management status, a transmission power value, and a minimum throughput value.

29. The apparatus of claim 28, wherein the processor is further configured to execute the instructions to determine a power/resource management procedure triggering condition for triggering an adjustment of the transmission power value of one or both of the network entity and the proximate network entity based on the one or more power/resource partitioning characteristics.

30. The apparatus of claim 29, wherein to determine the power/resource management procedure triggering condition, the processor is further configured to execute one or both of the instructions to:
determine that a number of high demand UEs meets or exceeds a high demand UE load threshold value; and
determine that a number of reduced communication quality UEs meets or is less than a reduced communication quality UE threshold value.
